(19) United States
(12) Patent Application Publication
(10) Pub. No.: US 2024/0125890 A1
(43) Pub. Date: Apr. 18, 2024

(54) METHOD AND DEVICE FOR COMMUNICATION IN WIRELESS COMMUNICATION SYSTEM SUPPORTING MULTIPLE RECONFIGURABLE INTELLIGENT SURFACES (RIS)

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Geonwoong JUNG, Suwon-si (KR); Byonghyo SHIM, Seoul (KR); Hyunsoo KIM, Seoul (KR); Yongsuk BYUN, Seoul (KR)

(21) Appl. No.: 18/472,498

(22) Filed: Sep. 22, 2023

(30) Foreign Application Priority Data
Sep. 22, 2022 (KR) 10-2022-0120361
Nov. 11, 2022 (KR) 10-2022-0150902

(51) Int. Cl. G01S 5/02; H04B 7/04

(52) U.S. Cl. CPC G01S 5/0273; H04B 7/04013

(57) ABSTRACT

The present disclosure relates to a method and device for communication by a base station in a wireless communication system supporting multiple reconfigurable intelligent surface (RIS) devices. According to an embodiment A method for operating a base station, the method comprises selecting at least two reference reconfigurable intelligent surface (RIS) devices for estimating a position of a user equipment (UE) from among a plurality of RIS devices, estimating position information about the UE using the selected at least two reference RIS devices, receiving an uplink pilot signal of the UE through the selected at least two reference RIS devices; and estimating a multi-RIS channel for the plurality of RIS devices based on the uplink pilot signal of the UE and the estimated position information about the UE.

### CROSS-REFERENCE TO RELATED APPLICATIONS

This application is based on and claims priority under 35 U. S.C. § 119 to Korean Patent Application Nos. 10-2022-0120361 and 10-2022-0150902, which were filed in the Korean Intellectual Property Office on Sep. 22, 2022 and Nov. 11, 2022, the entire disclosure of which is incorporated herein by reference.

### BACKGROUND

### 1. Field

The present disclosure relates to a communication method and device using reconfigurable intelligent surface (RIS) technology in a wireless communication system.

### 2. Description Of Related Art

5G mobile communication technology defines a wide frequency band to enable fast transmission speed and new services and may be implemented in frequencies below 6GHz (‘sub 6 GHz’), such as 3.5 GHz, as well as in ultra-high frequency bands (‘above 6 GHz’), such as 28 GHz and 39 GHz called millimeter wave (mmWave). Further, 6G mobile communication technology, which is called a beyond 5G system, is being considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive MIMO for mitigating propagation path loss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step RACH for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring numbers of connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

Additionally, RIS technology is being researched as one of the next-generation communication technologies. In RIS technology, a reflection pattern of reflecting elements (REs) included in the RIS device is formed as a combination of phase and/or amplitude, and the transmission beam of the base station incident on the RIS device may be reflected in a desired direction according to the reflection pattern. It is possible to transfer the transmission beam incident on the RIS device to the UE located in the shadow area where the transmission beam cannot reach from the base station by reflecting the transmission beam.

### SUMMARY

The present disclosure provides an efficient communication method and device in a wireless communication system supporting multiple RISs.

The present disclosure provides a multi-RIS-based channel estimation method and device capable of reducing the overhead of an uplink pilot signal (reference signal).

The present disclosure provides a method and device for providing multi-RIS code book information in a wireless communication system supporting multiple RISs.

According to an embodiment, a method for operating a base station comprises selecting at least two reference reconfigurable intelligent surface (RIS) devices for estimating a position of a user equipment (UE) from among a plurality of RIS devices, estimating position information about the UE using the selected at least two reference RIS devices, receiving an uplink pilot signal of the UE through the selected at least two reference RIS devices, and estimating a multi-RIS channel for the plurality of RIS devices based on the uplink pilot signal of the UE and the estimated position information about the UE.

According to an embodiment, a base station comprises a transceiver and a processor configured to select at least two reference reconfigurable intelligent surface (RIS) devices for estimating a position of a user equipment (UE) from among the plurality of RIS devices, estimate position information about the UE using the selected at least two reference RIS devices, receive, via the transceiver, an uplink pilot signal of the UE through the selected at least two reference RIS devices, and estimate a multi-RIS channel for the plurality of RIS devices based on the uplink pilot signal of the UE and the estimated position information about the UE.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 illustrates an example wireless communication system using a single RIS;

FIGS. 2A and 2B illustrate an example wireless communication system supporting multiple RISs according to an embodiment;

FIG. 3 illustrates a multi-RIS-based channel estimation method according to an embodiment;

FIGS. 4A, 4B, and 4C illustrates a communication method in a wireless communication system supporting multiple RISs according to an embodiment;

FIG. 5 illustrates a method for selecting a reference RIS device according to an embodiment;

FIG. 6 illustrates a method for estimating a position of a UE using a reference RIS device according to an embodiment;

FIG. 7 illustrates a method for estimating multiple RIS channels based on position information about a UE according to an embodiment;

FIG. 8 illustrates the operation of step 402 in FIG. 4A;

FIG. 9 illustrates a method for determining whether there is a direct path between a base station and a UE according to an embodiment;

FIG. 10 illustrates an example in which a phase compensation factor applies to each of multiple RIS devices 200 according to an embodiment;

FIGS. 11 and 12 illustrate simulation results when codebook (RIS codeword set) information applies considering multiple RISs in a wireless communication system according to an embodiment;

FIG. 13 illustrates an example configuration of an RIS device in a wireless communication system according to an embodiment; and

FIG. 14 illustrates a configuration of a network entity in a wireless communication system according to an embodiment.

### DETAILED DESCRIPTION

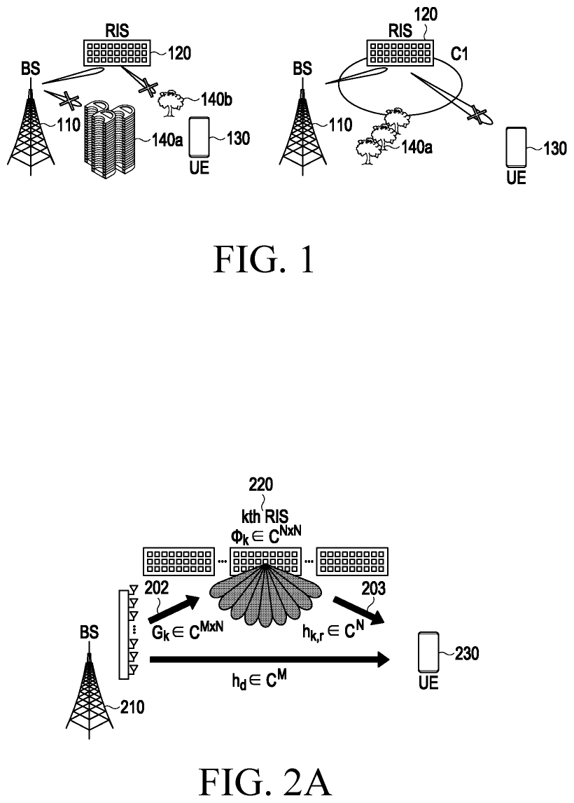

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the present disclosure is described below with reference to the accompanying drawings. When determined to make the subject matter of the present disclosure unclear, the detailed of the known functions or configurations may be skipped. The terms as used herein are defined considering the functions in the present disclosure and may be replaced with other terms according to the intention or practice of the user or operator. Therefore, the terms should be defined based on the overall present disclosure.

Advantages and features of the present disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

It should be appreciated that the blocks in each flowchart and combinations of the flowcharts may be performed by computer program instructions.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, a ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “. . . unit” may include one or more processors.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for ease of description. Thus, the present disclosure is not limited to the terms, and the terms may be replaced with other terms denoting objects with equivalent technical meanings.

In the present disclosure, the base station (BS) is a network entity allocating resources to the UE and capable of communicating with the UE and may be at least one of an eNode B, a Node B, a gNB, a radio access network (RAN), an access network (AN), a RAN node, an integrated access/backhaul (IAB) node, a radio access unit, a base station controller, a node over network, or a transmission reception point (TRP). The user equipment (UE) may be at least one of a terminal, a mobile station (MS), cellular phone, smartphone, computer, or multimedia system capable of performing communication functions.

The 3GPP standard standardized the 5G network system architecture and procedures. A mobile network operator may provide various services in a 5G network. To provide each service, the mobile network operator needs to meet different service requirements (e.g., latency, communication range, data rate, bandwidth, reliability, etc.) for each service. To that end, the 5G system may support network slicing (or may be referred to as the network slice), and traffic for different network slices may be handled by different PDU sessions. The PDU session may mean an association between a data network providing a PDU connection service and a UE. The network slice may be understood as technology for logically configuring a network with a set of network functions (NF) to support various services with different characteristics, such as wideband communication services, massive IoT, V2X, or other mission critical services, and separating different network slices. Therefore, even when a communication failure occurs in one network slice, communication in other network slices is not affected, so that it is possible to provide a stable communication service. To that end, the mobile network operator may constitute the network slice and may allocate network resources suitable for a specific service for each network slice or for each set of network slices. The network resource may mean a network function (NF) or logical resource provided by the NF or radio resource allocation of a base station. For example, the mobile network operator may configure network slice A for providing a mobile wideband service, network slice B for providing a vehicle communication service, and network slice C for providing an IoT service. In other words, the 5G system may efficiently provide a corresponding service to a UE through a specialized network slice suited for the characteristics of each service.

FIG. 1 illustrates an example wireless communication system using a single RIS.

The system of FIG. 1 assumes a communication environment in which a single RIS device 120 is installed around a base station BS 110, and obstacles 140a and 140b forming a shadow area are present around a user equipment (UE) 130 (FIG. 1(a)), or the UE 130 is positioned outside the service area C1 of the single RIS device 120. In such a communication environment, even if the single RIS device 120 forms a reflection pattern of reflecting elements (REs) in a combination of phase and/or amplitude and reflects the transmission beam of the base station 110 incident on the RIS device 120 toward the UE 130 according to the reflection pattern, the UE 130 in the shadow area cannot receive the reflected transmission beam because of the obstacles 140a and 140b or because it leaves the service area C1.

Since most of the existing RIS studies considered a single RIS device as in the example of FIG. 1, cooperative communication (cooperative control) using a base station and multiple RIS devices is impossible, and enhancing frequency efficiency is limited. In a single RIS environment, as illustrated in FIG. 1, both the direct path of the “base station-UE” and the reflection path of the “base station-RIS device-UE” may be disconnected, and in this case, the signal quality experienced by the UE may be significantly deteriorated. Since a single RIS device installed at a fixed position may provide a service only in a surrounding area close to the RIS device, if the UE moves far away from the RIS device, the data demand may not be met. Therefore, there is a need for a multi-RIS operation technology that enhances the performance (data transmission rate, reliability, cell coverage, etc.) of a communication system by cooperatively controlling a plurality of RIS devices to change the characteristics of radio waves.

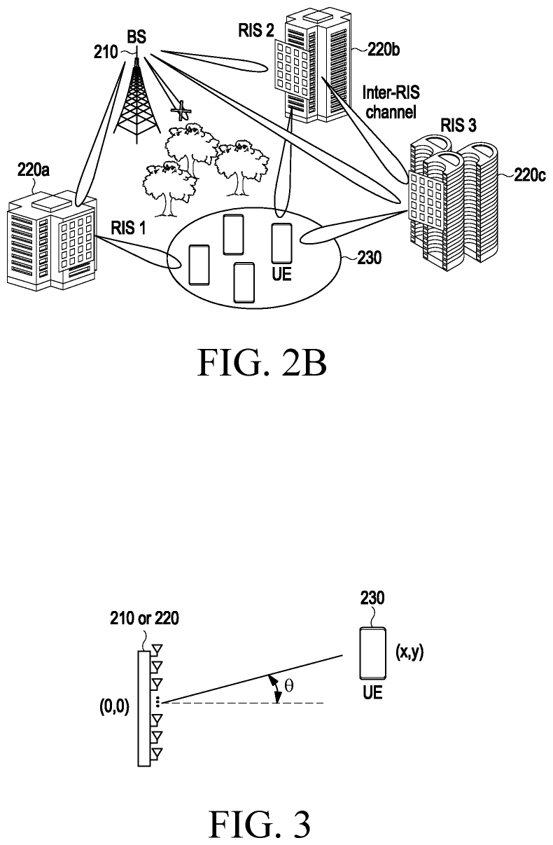

FIGS. 2A and 2B illustrate an example wireless communication system supporting multiple RISs according to an embodiment.

In the system of FIG. 2A, K multiple RIS devices 2201, . . . 220k, . . . , 220K: 220) (where K≥2) may be installed around a base station 210, and each of one or more RIS devices among the multiple RIS devices 220 may form a reflection pattern of reflecting elements (RE) in a combination of phase and/or amplitude and reflect the transmission beam of the base station 210 incident on each RIS device toward the UE 230 according to the reflection pattern. In the system of FIG. 2A, the UE 230 may receive a signal of an enhanced quality by combining the signal of the transmission beam transferred directly from the base station 210 through the path 201 and the signal of the transmission beam reflected and transferred through the reflection paths 202 and 203.

In the example of FIG. 2A, the channel (i.e., BS-UE channel) of the direct path 201 may be represented as h_{d}∈ [symbol] ^{M}, the channel (i.e., BS-RIS channel) between the base station 210 and the kth RIS device 220k in the reflection paths 202 and 203 may be represented as Gₖ∈ [symbol] ^{M×N}, and the channel (i.e., RIS-UE channel) between the kth RIS device 220k and the UE 230 may be represented as h_{k,r}∈ [symbol] ^{N}. In the example of FIG. 2A, the phase shift matrix Φₖ used when the kth RIS device 220k reflects the transmission beam may be selected from a pre-defined codebook. information about the codebook may be provided to each RIS device from the base station 210 estimating the channel in the reflection path of each RIS device. The signal (y), which is a combination of signals received from the UE 230 through the direct path 201 and the reflection paths 202 and 203 of the multiple RIS devices 220, may be expressed as Equation 1 below.

$$\begin{matrix}y = {( {h}_{d} + {\sum }_{k = 1} {G}_{k} {Φ}_{k} {h}_{k , r} )}^{H} ws + n \\ = {\tilde{h}}^{H} ws + n\end{matrix} \qquad [ Equation 1 ]$$

The definitions of the variables in Equation 1 above are as shown in Table 1 below.

TABLE 1

N : number of RIS reflecting elements
M : number of base station antennas
K : number of RIS devices
h_{d} : BS-UE channel
hᵣ : IS-UE channel
Gₖ : BS-RIS channel
Φₖ : phase shift matrix
s : transmission signal
w : base station beamforming vector
n : noise component

In the example of FIG. 2A, in the communication environment in which the multiple RIS devices 220 operate, unlike the communication environment in which the single RIS device 120 operates in the example of FIG. 1, the channel between the base station 210 and the UE 230 is expressed as the sum of channels of multiple reflection paths of the multiple RIS devices 220. The phase shift matrix of multiple RIS devices 220 in the system of FIG. 2 may be jointly determined for multiple reflection paths.

As illustrated in FIG. 2B, in a communication environment using multiple RIS devices 220a, 220b, and 220c, the UE 230 receiving the transmission beam of the base station 210 through multiple reflection paths by the multiple RIS devices 220a, 220b, and 220c may obtain a spatial diversity gain.

In the example of FIGS. 2A and 2B, channel information between the base station 210 and the multiple RIS devices 220 and channel information between the multiple RIS devices 220 and UE 230 are used to jointly determine multiple RIS beams reflected by the multiple RIS devices 220a, 220b, and 220c: 220. In order for the base station 210 to estimate the entire channel information considering the multiple RIS devices 220, the overhead of the pilot signal (i.e., a reference signal) transmitted from the UE 230 to the base station 210 through each of the multiple RIS devices 220 in the uplink is significantly increased. Therefore, there is a need for a method for reducing the overhead of the pilot signal (reference signal) used for channel estimation (hereinafter, multi-RIS-based channel estimation) considering the multiple RIS devices 220.

FIG. 3 illustrates a multi-RIS-based channel estimation method according to an embodiment.

Referring to FIG. 3, since line-of-sight (LoS) (i.e., a direct path) is dominant in an mmWave signal such as in a 5G system, channel parameters (e.g., angle of arrival (AoA), angle of departure (AoD), path loss, etc.) may be represented as position information about the base station 210, the RIS device 220, and/or the UE 230 as shown in Equation 2 and Equation 3 below. In Equation 3, path loss means the path loss of radio waves during communication in a free space, c means the speed of light, and f means the frequency of the signal.

$$AoA θ = {tan}^{- 1} ( \frac{y}{x} ) \qquad [ Equation 2 ]$$

$$Path loss PL = {( \frac{4 π f}{c} )}^{2} ( {x}^{2} + {y}^{2} ) \qquad [ Equation 3 ]$$

As illustrated in FIG. 2A, in a wireless communication system operating multiple RIS devices 220, a channel for each RIS device of the multiple RIS devices 220 may be estimated based on position information about the base station 210, the RIS device 220, and/or the UE 230. In the present disclosure, when the base station 210 estimates a multi-RIS channel, it may be understood that the base station 210 estimates a channel for each RIS device of the multiple RIS devices 220. The present disclosure proposes a method for selecting some RIS devices (e.g., two or three RIS devices) among K multiple RIS devices 220 as reference RIS devices in order to reduce the overhead of pilot signals (reference signals) transmitted from the UE 230 when estimating multi-RIS-based channels. When two reference RIS devices are selected, the position information about the UE 230 may be represented by a two-dimensional coordinate system (x, y), and when three reference RIS devices are selected, the position information about the UE 230 may be represented by a three-dimensional coordinate system (x, y, z). Hereinafter, for convenience of description, an example of selecting two reference RIS devices is described.

In the present disclosure, multi-RIS-based channel estimation using a reference RIS device is performed by the base station 210, and may be performed in the three-step operation as follows:
Step 1: Select a reference RIS device for estimating the position of the UE from among multiple RIS devices
Step 2: Estimate the position of the UE using the selected reference RIS device
Step 3: Estimate multi-RIS channel based on estimated UE position information

Hereinafter, the method of steps 1, 2, and 3 is described in detail with reference to FIGS. 5 to 7.

FIG. 5 illustrates a method for selecting a reference RIS device according to an embodiment.

Referring to FIG. 5, step 1 is described. The base station 210 may select Q (e.g., Q=2) reference RIS devices 220a and 220b as a small number of reference RIS devices for estimating the position of the UE 230 from among a total of K multiple RIS devices 220. Even if the total number K of the multiple RIS devices 220 increases, the overhead of the pilot signals (reference signals) remains constant without increasing because the number of reference RIS devices is two when estimating the multi-RIS-based channel. Assuming that the base station 210, the reference RIS devices 220a and 220b, and the UE 230 are positioned on a two-dimensional plane, position information about the UE 230 may be obtained from the reference RIS devices 220a and 220b. In step 1, the reference RIS devices 220a and 220b may be selected using Equation 4 below based on the direct path of the base station 210 and the UE 230 and the distance (BS-RIS distance) between the base station 210 and each RIS device.

$${min}_{z} {z}^{T} ( d + λθ ) \qquad [ Equation 4 ]$$

$$s . t . {‖ z ‖}_{1} = Q$$

$${z}_{k} ∈ \{ 0 , 1 \} \text{?}$$

$$θ = {[ \vert {θ}_{1} \vert , … , \vert {θ}_{K} \vert ]}^{T} : angle difference vector$$

$${θ}_{k} = {tan}^{- 1} ( \frac{{y}_{k} - {y}_{BS}}{{x}_{k} - {x}_{BS}} ) - {θ}_{di}$$

$$d = {[ {d}_{1} , … , {d}_{K} ]}^{T} : BS - RIS distance vector$$

$${d}_{k} = \sqrt{{x}_{k}^{2} + {y}_{k}^{2}}$$

$$\text{?} \text{indicates text missing or illegible when filed}$$

In Equation 4, z denotes the reference RIS selection vector and, as an example, z=0 means that it is selected as the reference RIS device, and z=1 means that it is not selected as the reference RIS device. For example, when the first and third RIS devices are selected from among the four multiple RIS devices, the reference RIS selection vector may be expressed as z=[1, 0, 1, 0]^{T}. Q means the number of RIS devices selected as z=1, i.e., the number of reference RIS devices. The reference RIS device is selected so that Q has a small value (e.g., Q=2). The position information about the kth RIS device 220k among the K multiple RIS devices 220 is expressed as (xₖ, yₖ), and the position information about the base station 210 is expressed as (xBS, yBS). In relation to “d+λθ” in Equation 4, θ is a term for selecting RIS devices having paths similar in direction to the direct path (straight path) between the base station 210 and the UE 230 as the reference RIS devices 220a and 220b, and d is a term for selecting RIS devices close to the base station 210 as the reference RIS devices 220a and 220b. λ is a weight for determining the precedence of two references (direction and distance) for selecting the reference RIS devices 220a and 220b. For example, in the case of k, RIS devices close to the base station 210 may be selected as the reference RIS devices 220a and 220b without considering the direction.

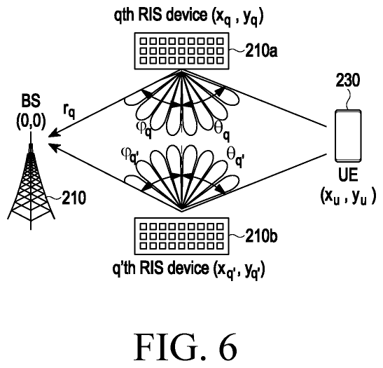

FIG. 6 illustrates a method for estimating a position of a UE using a reference RIS device according to an embodiment.

Referring to FIG. 6, step 2 is described. The position information (xᵤ, yᵤ) about the UE 230 may be estimated as in Equation 5 below based on position information (x_{q}, y_{q}), (x_{q}′, y_{q}′) about the reference RIS devices 210a and 210b and angle information θ_{q}, θ_{q}′ between each of the reference RIS devices 210a and 210b and the UE 230. Here, it is assumed that the position information about the base station 210 is (0, 0).

$${x}_{u} = \frac{{x}_{{q}^{′}} tan {θ}_{q} - {x}_{q} tan {θ}_{{q}^{′}}}{tan {θ}_{q} - tan {θ}_{{q}^{′}}} , \qquad [ Equation 5 ]$$

$${y}_{u} = \frac{- ( {x}_{q} - {x}_{{q}^{′}} ) + {y}_{q} tan {θ}_{q} - {y}_{{q}^{′}} tan {θ}_{{q}^{′}}}{tan {θ}_{{q}^{′}} - tan {θ}_{q}}$$

In Equation 5 above, the angle θ_{q} may be the angle for the UE 230 in the reflection path of the qth reference RIS device 210a in FIG. 6, and may be estimated using beam sweeping on the reference RIS device 220a. The angle θ_{q} may be determined as in Equation 19 below.

$${θ}_{q} = {arg max}_{θ} \vert {r}_{q} \vert = {arg max}_{θ} \vert {( {G}_{k} {Φ}_{q} ( {φ}_{q} , θ ) {h}_{r , k} )}^{H} {s}_{q} + {n}_{q} \vert \qquad [ Equation 5 ]$$

For the variables in Equation 5, refer to Table 1 above. The subscript q means the variable for the qth RIS device.

The phase shift matrix Φ_{q}(φ_{q}, θ) used when the qth RIS device 220a reflects the transmission beam incident from the base station may be obtained as in Equation 6 from the codebook (i.e., RIS codeword set) information.

$$RIS codeword {Φ}_{q} ( {φ}_{q} , θ ) = diag ( [ 1 , {e}^{i \frac{d}{2 λ} ( sin ( {φ}_{q} ) + sin ( θ ) )} , … , {e}^{i ( N - 1 ) \frac{d}{2 λ} ( sin ( {φ}_{q} ) + sin ( θ ) )} ] ) \qquad [ Equation 6 ]$$

Equation 5 and Equation 6 above may also be applied to the q′th RIS device 210b.

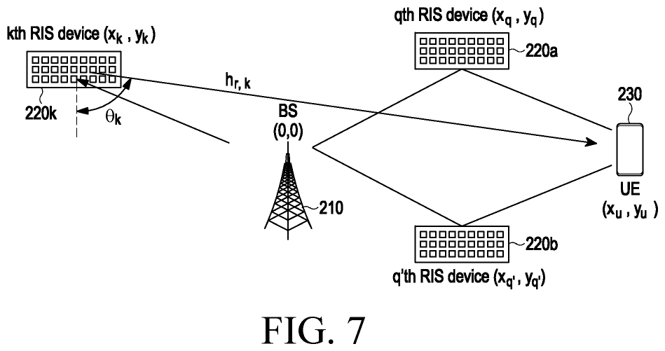

FIG. 7 illustrates a method for estimating multiple RIS channels based on position information about a UE according to an embodiment.

Referring to FIG. 7, step 3 is described. The channel h_{r,k} in the reflection path between the UE 230 and the kth RIS device 220k except for the reference RIS devices 210a and 210b may be estimated as in Equation 7 below, based on the position information (x_{q}, y_{q}), (x_{q}′, y_{q}′) about the reference RIS devices 210a and 210b, the position information (xᵤ, yᵤ) about the UE 230 estimated based on the angle information between each of the reference RIS devices 210a and 210b and the UE 230, and the position information (xₖ, yₖ) about the kth RIS device 220k.

$${h}_{r , k} = PL ( \sqrt{{( {x}_{k} - {x}_{u} )}^{2} + {( {y}_{k} - {y}_{u} )}^{2}} ) a ( {θ}_{k} ) \qquad [ Equation 7 ]$$

$${θ}_{k} = {tan}^{- 2} ( \frac{{x}_{u} - {x}_{k}}{{y}_{u} - {y}_{k}} )$$

In Equation 7 above, the variables are defined as shown in Table 2 below. In Equation 7 above, the variable a(θₖ) is the steering vector indicating the channel direction of the kth RIS device 220k.

TABLE 2

PL(d): path loss
a(θ): array steering vector
θₖ : AoD between RIS and UE

In the present disclosure, by using the method of steps 1, 2, and 3 described above, the base station 210 may select a minimum number of reference RIS devices, estimate the position of the UE 230 using the selected reference RIS devices, and estimate a channel for each RIS device of the K multiple RIS devices 220 based on the position information about the UE 230.

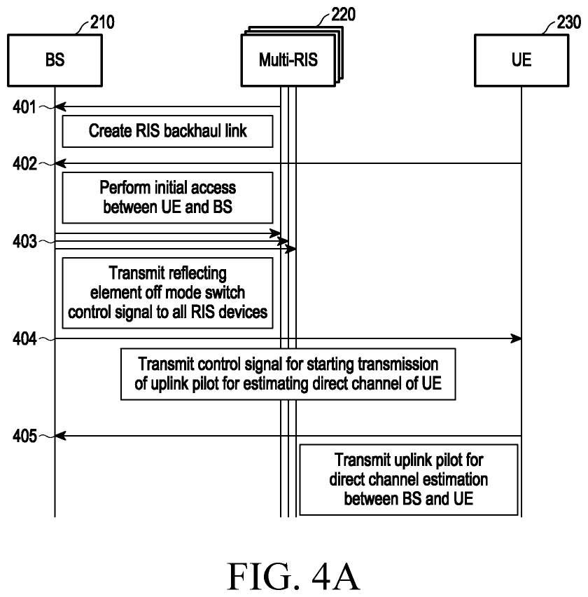

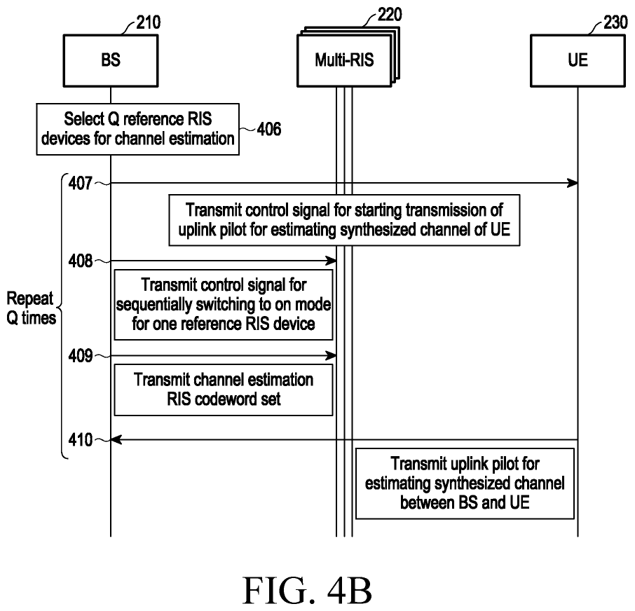

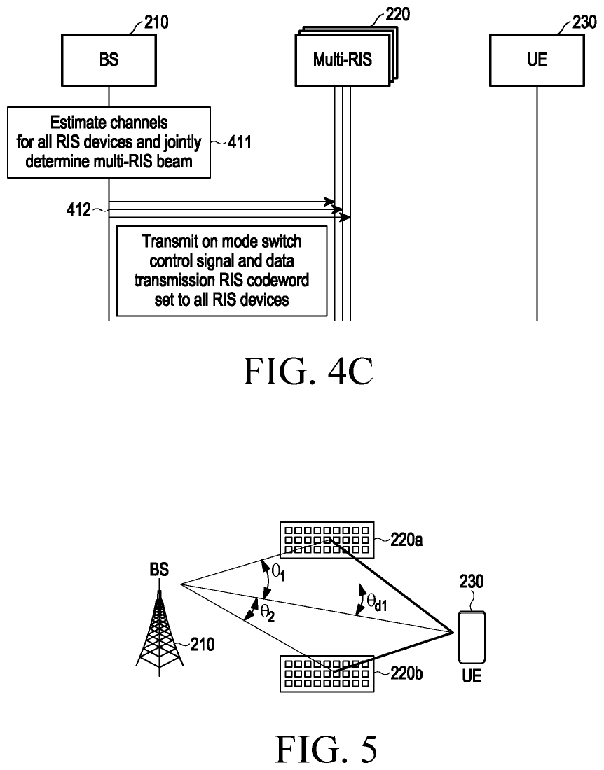

FIGS. 4A, 4B, and 4C illustrate a communication method in a wireless communication system supporting multiple RISs according to an embodiment.

In step 401 of FIG. 4A, the base station 210 creates/establishes a wired or wireless backhaul link with K (K≥2) multiple RIS devices 220. The backhaul link is distinguished from reflection paths in which the multiple RIS devices 220 receive the transmission beams of the base station 210 and reflect them. Each RIS device of the multiple RIS devices 220 may provide its own position information to the base station 210 through the backhaul link. Further, when the multiple RIS devices 220 are installed in fixed positions, position information about the multiple RIS devices 220 may be previously stored in the base station 210. Changed position information in which the position information about at least one of the multiple RIS devices 220 has been changed may be provided from the corresponding RIS device to the base station 210.

In step 402, upon initial access by the UE 230, the base station 210 may perform an initial access procedure (e.g., random access procedure) with the UE 230.

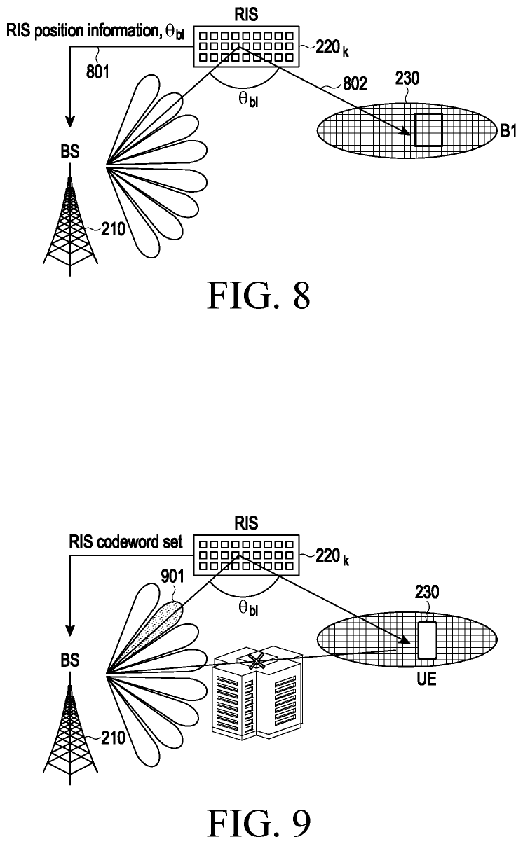

Referring to FIG. 8, the operation of step 402 is described. The example of FIG. 8 assumes that the UE 230 is located in a shadow area B1 (e.g., a frequent blockage zone of the communication state). In this case, the base station 210 beam-forms the signal transmitted in the initial access procedure and transmits it to the kth RIS device 220k. Here, the RIS device 220k is one of K RIS devices 200. The base station 210 may receive at least one of the position information and angle information θ_{b1} about the corresponding RIS device 220k through the backhaul link from the RIS device 220k before the initial access procedure (801). In another embodiment, the base station 210 may previously store the position information and angle information θ_{b1} about the RIS device 220k as a setting value. The base station 210 may provide codebook information (RIS codeword set) information to the RIS device 220k capable of reflecting the transmission beam of the base station toward the shadow area B1 (i.e., at the angle of θ_{b1}) through the backhaul link. The codebook information is used for the RIS device 220k to create a reflection pattern for reflecting the transmission beam. The UE 230 in the shadow area B1 may receive (802) the signal reflected through the RIS device 220k and perform the initial access procedure.

In step 403, the base station 210 transmits a first control signal (information) for instructing to switch the off mode in which the reflecting elements (REs) do not operate to each RIS device of the multiple RIS devices 220 through the backhaul link.

In step 404, the base station 210 transmits a second control signal (information) for instructing to transmit an uplink pilot signal (reference signal) for channel estimation in the direct path between the base station 210 and the UE 230 to the UE 230.

In step 405, the UE 230 receiving the second control signal transmits an uplink pilot signal to the base station 210.

Meanwhile, when there is no direct path between the base station 210 and the UE 230 due to a shadow area, the operations of steps 403 to 405 may be omitted.

Referring to FIG. 9, the operation of determining whether there is a direct path between the base station 210 and the UE 230 by the base station 210 is described. The base station 210 may measure the strength of the reception signal from the UE 230 and may determine that there is no direct path if the strength of the reception signal from the UE is smaller than predetermined threshold (or smaller than or equal to the threshold) and may determine that there is a direct path if the strength of the reception signal is equal to or larger than the threshold (or larger than the threshold). When there is no direct path, the base station may receive a signal from the UE 230 through, e.g., the reflection path 901 of the kth RIS device 220k. The codebook (RIS codeword set) information for signal reflection in the direction from the kth RIS device 220k may be previously provided to the kth RIS device 220k by the base station.

Thereafter, in step 406 of FIG. 4B, the base station 210 selects Q (e.g., at least two) reference RIS devices 210a and 210b for position estimation of the UE 230 from among the multiple RIS devices 220.

The operation of the base station 210 to select the reference RIS devices 210a and 210b in step 406 above may use the method of Equation 4 as in the operation of step 1 in the three-step operation of multi-RIS-based channel estimation using the reference RIS device. Equation 4 assumes that there is a direct path between the base station 210 and the UE 230. When there is no direct path, the base station 210 may be unaware of the direction of the direct path (i.e., in the example of FIG. 3, the base station 210 may not know the angle θ in the direct path between the base station 210 and the UE 230). Thus, the method of Equation 4 may be used when selecting the reference RIS device. In this case, the base station 210 may select the reference RIS devices in order from the shortest BS-RIS distance based on the distance (BS-RIS distance) between the base station 210 and the kth RIS device 220k except for the angle θ in the direct path.

$${min}_{z} {z}^{T} d \qquad [ Equation 8 ]$$

$$s . t . {‖ z ‖}_{1} = Q$$

$${z}_{k} ∈ \{ 0 , 1 \} \text{?}$$

$$d = {[ {d}_{1} , … , {d}_{K} ]}^{T} : BS - RIS distance vector$$

$${d}_{k} = \sqrt{{x}_{k}^{2} + {y}_{k}^{2}}$$

$$\text{?} \text{indicates text missing or illegible when filed}$$

In step 407, the base station 210 selecting the reference RIS devices 210a and 210b transmits a third control signal (information) for instructing to start transmission of the uplink pilot signal (reference signal) to the UE 230 to estimate a synthesized channel of the channels in the reflection paths of the multiple RIS devices 220. The third control signal may include wait time information for the UE 230 to transmit an uplink pilot signal (reference signal) after receiving the third control signal considering the time used for steps 408 and 409 described below. For example, after receiving the third control signal, the UE 230 may wait by the wait time (which may be indicated as, e.g., the number of slots, the number of symbols, or time offset) indicated in the wait time information and then transmits an uplink pilot signal (reference signal).

In steps 408 and 409, the base station 210 transmits a fourth control signal (information) for instructing to sequentially switch to the on mode in which the reflecting elements (REs) operate to the reference RIS devices 210a and 210b through the backhaul link and transmits codebook (RIS codeword set) information for channel estimation.

In step 410, the base station 210 receives the uplink pilot signal (reference signal) for estimating the synthesized channel of the channels in the reflection paths of the multiple RIS devices 220 from the UE 230 receiving the third control signal. The operations of steps 407 to 410 are repeated Q times, where Q is the number of the reference RIS devices 210a and 210b. In other words, the operations of steps 407 to 410 are performed on the reference RIS devices 210a, and then, the operations of steps 407 to 410 are repeatedly performed on the reference RIS devices 210b.

Thereafter, in step 411, the base station 210 performs channel estimation on each of the total of K RIS devices 200 and determines a transmission beam(s) to be reflected to the UE 230 through the RIS devices 200. In the present disclosure, the channel estimation method for each of the RIS devices 200 may be performed through the operations of steps 2 and 3 in the three-step operation of multi-RIS-based channel estimation.

In step 412, the base station 210 transmits a fifth control signal (information) for instructing to switch to the on mode in which the reflecting elements (REs) operate to the total of K RIS devices 200 through the backhaul link and transmits codebook (RIS codeword set) information for data transmission. In step 412, an example in which all of the total of K RIS devices 200 operate in the on mode is described. However, it is also possible to allow some 200 of the total of K RIS devices 200 to operate in the on mode based on the position information about the UE 230. The number of the some RIS devices 200 may be set in a range smaller than K.

According to the method of FIGS. 4A to 4C described above, the base station 210 may select a small number of reference RIS devices 210a and 210b from among the total K of RIS devices 200 to reduce the overhead of the uplink pilot signal (reference signal) received from the UE 230 for channel estimation and may efficiently perform communication using the multiple RIS devices 200.

In the present disclosure, in step 412, the codebook (RIS codeword set) information for data transmission to each RIS device of the K RIS devices 200 from the base station 210 may be designed in the following manner.

In a communication environment where the multiple RIS devices 200 operate, the UE 230 may receive the signals reflected through the multiple RIS devices 200, and the combined signal r of the reception signals may be expressed as in Equation 9 below.

r=(h_{d}+Σₖ₌₁^{K}GₖΦₖh_{r,k})^{H}ws+n [Equation 9]

When the signals reflected from the multiple RIS devices 200 are not phase-aligned, the beamforming gain of the multiple RIS devices 200 may be reduced due to destructive interference between the reflected signals as shown in Equation 10 below.

$$\begin{matrix}\text{?} {( {G}_{1} {Φ}_{1} {h}_{r , 1} )}^{H} w + & {( {G}_{2} {Φ}_{2} {h}_{r , 2} )}^{H} w {\text{?}}^{2} = \text{?} {α}_{1} {\text{?}}^{2} + \text{?} {α}_{2} {\text{?}}^{2} + 2 {α}_{1} {α}_{2} & Re \{ e \text{?} \} \\ \text{?} & \text{?} & \text{?} \\ {α}_{1} {e}^{j {φ}_{1}} & {α}_{2} {e}^{j {φ}_{2}} & destructive interference occurs\end{matrix} \qquad [ Equation 10 ]$$

$$\text{?} \text{indicates text missing or illegible when filed}$$

When only the direction of the reflected beam is indicated in the codebook (RIS codeword set) information, the beamforming gain of the multiple RIS devices 200 may be reduced since the signals reflected through the multiple RIS devices 200 cannot be phase-aligned.

Therefore, the present disclosure proposes a phase compensation factor for aligning the phases of the signals reflected from the multiple RIS devices 200. The phase compensation factor may be provided in such a manner as to set q₁ and q₂ so that Re{ } in Equation 11 below is “1.”

$$[ Equation 11 ]$$

$$\begin{matrix}\text{?} {( {G}_{1} ( e \text{?} {Φ}_{1} ) {h}_{r , 1} )}^{H} w + {( {G}_{2} ( e \text{?} {Φ}_{2} ) {h}_{r , 2} )}^{H} w = \text{?} {α}_{1} {\text{?}}^{2} + \text{?} {α}_{2} {\text{?}}^{2} + \\ 2 {α}_{1} {α}_{2} Re \{ e \text{?} \} \\ = \text{?} {α}_{1} {\text{?}}^{2} + \text{?} {α}_{2} {\text{?}}^{2} + \\ 2 {α}_{1} {α}_{2} ,\end{matrix}$$

$$where {φ}_{1} - {φ}_{2} + {q}_{1} - {q}_{2} = 0$$

$$\text{?} \text{indicates text missing or illegible when filed}$$

In the present disclosure, when the phase compensation factor is e^{iθ}^{ₚ}, and the phase shift factor representing the phase shift matrix is Φₙ, the codebook (RIS codeword set) information may be represented as in Equation 12 below. The codebook (RIS codeword set) information may be represented as the product of and e^{iθ}^{ₚ} and Φₙ, i.e., the product of the phase compensation factor and the phase shift factor.

$$Φ ( p , n ) = {e}^{i {θ}_{p}} {Φ}_{n} \qquad [ Equation 12 ]$$

$${θ}_{p} = \frac{p}{{2}^{b}} 2 π$$

$$p = 1 , … , {2}^{b}$$

$$n = 1 , … , N$$

In Equation 12, N is the number of reflecting elements of each RIS device, p is the index of the phase compensation factor, b is the phase compensation quantization bit, and n is the index of the phase shift factor.

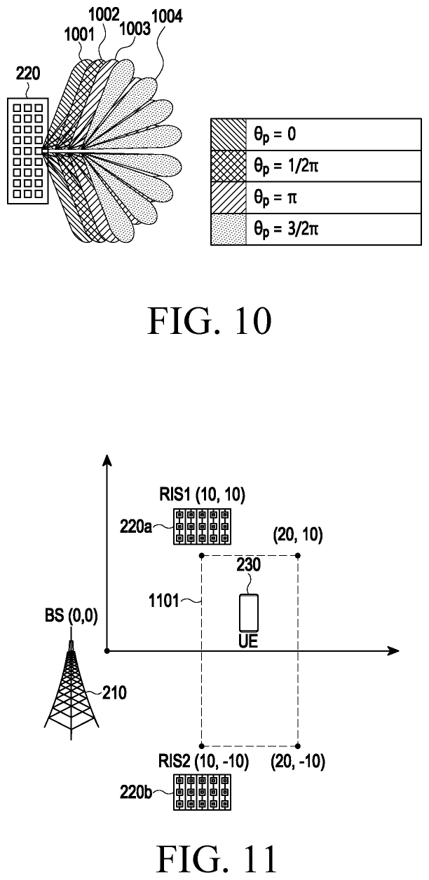

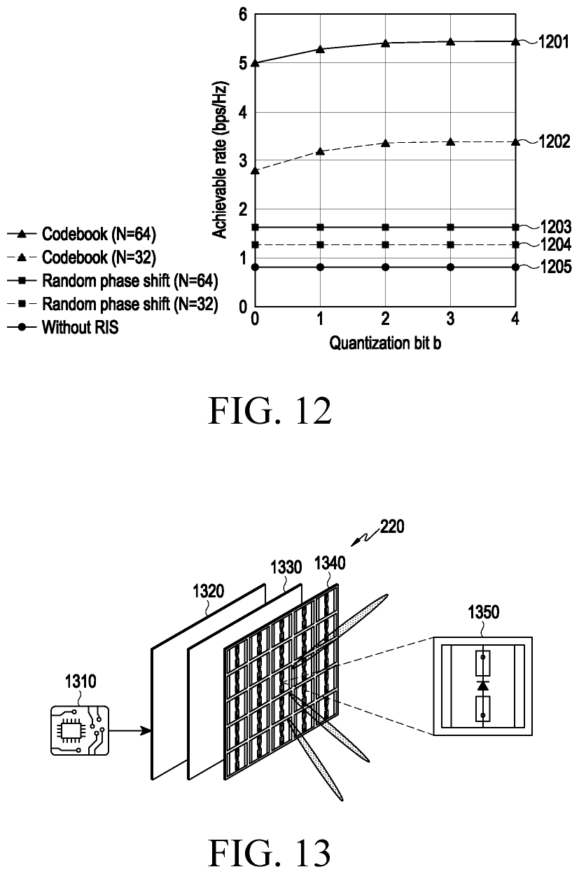

FIG. 10 illustrates an example in which a phase compensation factor is applied to each of multiple RIS devices 200 according to an embodiment. In the example of FIG. 12, the number N of the reflecting elements of each RIS device is 8, and the number b of phase compensation quantization bits is 2 (i.e., 2b=22=4). In this case, the phase compensation factor may have four cases where p=1, . . . , 4 as shown in FIG. 10, and reference numerals 1001 to 1004 exemplify reflected beams to which phase compensation shown as separate shading has been applied.

In the present disclosure, the codebook (RIS codeword set) information provided to each of the multiple RIS devices 200 from the base station 210 may include at least one of the index p (hereinafter, referred to as phase compensation information) of the phase compensation factor and the index n (hereinafter, referred to as phase shift information or beam direction information) of the phase shift factor indicating the beam direction.

The phase compensation information p and the phase shift information n may be provided to each of the multiple RIS devices 200 from the base station 210 using one of embodiments 1, 2, and 3 in Table 3 below. In Table 3 below, the time slot may be understood as a slot which is the unit of transmission as defined in, e.g., the 3GPP NR standard, and the phase compensation information p and the phase shift information n may be periodically transmitted or aperiodically transmitted according to a predetermined trigger condition, rather than being limited to transmission on a per-slot basis, in another embodiment.

TABLE 3
- embodiment 1: compensate for phase every time slot, transmit phase
shift index p, n
- embodiment 2: transmit codebook index q=N(p−1)+n every time slotΔ
- embodiment 3: transmit only differences Δp, Δn between previous time
slots
since beam continuously changes depending on the position of the
UE, reduce feedback overhead by transmitting only index differences Δp,
Δn
If (p,n)=(1,2) when t=1, and (p,n)=(3,4) when t=2, then
transmit only (Δp, Δn)=(+1,+1)
if index differences (Δp, Δn)=(0,0), maintain the previous time
slot RIS beam without providing feedback

FIGS. 11 and 12 illustrate simulation results when codebook (RIS codeword set) information applies considering multiple RISs in a wireless communication system according to an embodiment.

Referring to FIG. 11, multiple RIS devices 220a and 220b of the base station 210 may be installed, and each of the multiple RIS devices 220a and 220b may form a reflection pattern of reflecting elements (RE) in a combination of phase and/or amplitude and reflect the transmission beam of the base station 210 incident on each RIS device toward the UE 230 according to the reflection pattern. If it is assumed in FIG. 11 that the coordinates of the base station 210 are (0, 0), and the coordinates of the multiple RIS devices 220a and 220b are (10, 10) and (10, −10), respectively, it may be identified that the beams reflected by the multiple RIS devices 220a and 220b in the shaded area 1101 are generated uniformly and randomly. The simulation result of FIG. 11 assumes the conditions of Table 4 below.

TABLE 4

| Parameters | Values | |
|---|---|---|
| center frequency f | 5.9 | GHz |
| number N of RIS reflecting elements | 64, 32 | |
| number K of RIS devices | 2 | |
| noise σ² | −80 | dBm |

| | |
|---|---|
| number of samples | 1 × 10³ |

In the example of FIG. 12, the transmission rates (achievable rates) according to the number b of phase compensation quantization bits are compared for the respective cases of reference numerals 1201 to 1205, and it may be identified that as the number b of phase compensation quantization bits increases, the transmission rate increases. It may also be identified that as the number b of phase compensation quantization bits increases, the increase in transmission rate gradually decreases. Reference numerals 1201 and 1202 denote cases of applying phase compensation while operating multiple RIS devices according to the present disclosure, reference numerals 1203 and 1204 denote cases of operating multiple RIS devices according to the present disclosure without phase compensation, and reference numeral 1205 denotes a case of not operating multiple RIS devices.

FIG. 13 illustrates an example configuration of an RIS device in a wireless communication system according to an embodiment.

Referring to FIG. 13, an RIS device 220 includes an RIS controller 130, a control board 1320, a conductor plate 1330, and a reflection panel 1340 in which a plurality of reflection elements 1350 are arranged. The RIS controller 130 may include at least one processor (not shown) and a transceiver (not shown). The RIS controller 130 may communicate with the base station 210 through a backhaul link according to one of, or a combination of two or more of, the embodiments of the present disclosure described with reference to FIGS. 2 to 12, and controls the entire device through the control board 1320 such that the reflection panel 1340 operates. The conductor plate 1330 may use, e.g., a copper plate having conductivity.

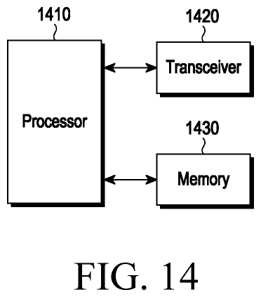

FIG. 14 illustrates a configuration of a network entity in a wireless communication system according to an embodiment. The configuration of FIG. 14 may be included in one of the base station 210, the RIS device 220, and the UE 230 described in the embodiments of FIGS. 2 to 13.

The network entity of FIG. 14 may include a processor 1410, a transceiver 1420, and a memory 1430. The processor 1410, transceiver 1420, and memory 1430 of the network entity may be operated according to the communication methods of the network entity described above in connection with the embodiments of FIGS. 2 to 13. However, the components of the network entity are not limited thereto. For example, the network entity may include more or fewer components than the above-described components. The processor 1410, the transceiver 1420, and the memory 1430 may be implemented in the form of a single chip.

The transceiver 1420 collectively refers to the receiver of the network entity and the transmitter of the network entity and may transmit and receive signals to/from a UE or another network entity. The transmitted/received signals may include at least one of control information and data. To that end, the transceiver 1420 may include a wired/wireless transceiver and may include various components for transmitting/receiving signals. The transceiver 1420 may receive signals through a predetermined communication interface, output the signals to the processor 1410, and transmit the signals output from the processor 1410. Further, the transceiver 1420 may receive the communication signal and output it to the processor 1410 and transmit the signal output from the processor 1410 to the UE or another network entity through the network. The memory 1430 may store programs and data used for the operation of the network entity according to at least one of the embodiments of FIGS. 1 to 13. Further, the memory 1430 may store control information or data that is included in the signal obtained by the network entity. The memory 1430 may include a storage medium, such as ROM, RAM, hard disk, CD-ROM, and DVD, or a combination of storage media. Further, the processor 1410 may control a series of processes so that the network entity may operate according to at least one of the embodiments of FIGS. 2 to 13. For example, the processor 1410 may include at least one processor.

The methods according to the embodiments described in the specification or claims of the present disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the present disclosure.

The programs (software modules or software) may be stored in random access memories, non-volatile memories including flash memories, read only memories (ROMs), electrically erasable programmable read-only memories (EEPROMs), magnetic disc storage devices, compact-disc ROMs, digital versatile discs DVDs), or other types of optical storage devices, or magnetic cassettes. Or, the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the present disclosure via an external port. A separate storage device over the communication network may be connected to the device that performs embodiments of the present disclosure.

In the above-described specific embodiments, the components included in the present disclosure are represented in singular or plural forms depending on specific embodiments proposed. However, the singular or plural forms are selected to be adequate for contexts suggested for ease of description, and the present disclosure is not limited to singular or plural components. As used herein, the singular forms “a,” “an,” and “the” are intended to include the plural forms as well, unless the context clearly indicates otherwise.

Although specific embodiments of the present disclosure have been described above, various changes may be made thereto without departing from the scope of the present disclosure. Thus, the scope of the present disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for operating a base station, the method comprising:
selecting at least two reference reconfigurable intelligent surface (RIS) devices for estimating a position of a user equipment (UE) from among a plurality of RIS devices;
estimating position information about the UE using the selected at least two reference RIS devices;
receiving an uplink pilot signal of the UE through the selected at least two reference RIS devices; and
estimating a multi-RIS channel for the plurality of RIS devices based on the uplink pilot signal of the UE and the estimated position information about the UE.

2. The method of claim 1, wherein the selecting includes selecting the at least two reference RIS devices based on a distance between the base station and each of the plurality of RIS devices and a direct path between the base station and the UE.

3. The method of claim 2, wherein the selected at least two reference RIS devices are selected in order of proximity to a direction of the direct path.

4. The method of claim 2, wherein the selected at least two reference RIS devices are selected based on the distance, a direction of the direct path, and weights indicating precedence for the distance and the direction.

5. The method of claim 1, wherein estimating the position information about the UE includes estimating the position information about the UE based on angle information between the UE and each of the selected at least two reference RIS devices and position information about the selected at least two reference RIS devices.

6. The method of claim 1, wherein estimating the multi-RIS channel for the plurality of RIS devices includes estimating a channel h_{r,k} in a reflection path between the UE and a kth RIS device except for the selected at least two reference RIS devices among the plurality of RIS devices, wherein the channel h_{r,k} is estimated through the following equation:
$${h}_{r , k} = PL ( \sqrt{{( {x}_{k} - {x}_{u} )}^{2} + {( {y}_{k} - {y}_{u} )}^{2}} ) a ( {θ}_{k} )$$
$${θ}_{k} = {tan}^{- 2} ( \frac{{x}_{u} - {x}_{k}}{{y}_{u} - {y}_{k}} )$$
wherein position information about the kth RIS device is (xₖ, yₖ), the position information about the UE is (xᵤ, yᵤ), a(θₖ)is a steering vector indicating a channel direction of the kth RIS device, a function of PL indicates a path loss based on a distance between the base station and the kth RIS device, and θₖ indicates an angle of departure (AoD) between the UE and the kth RIS device.

7. The method of claim 1, further comprising transmitting codebook (RIS codeword set) information for reflecting a transmission beam of the base station to the UE to each of the plurality of RIS devices, wherein the codebook information includes at least one of phase shift information and phase compensation information applied to reflect the transmission beam of the base station through a reflecting element of each RIS device, and wherein the phase shift information indicates a beam direction to each RIS device, and the phase compensation information is information for aligning phases of signals reflected from the plurality of RIS devices.

8. The method of claim 7, wherein the codebook information is defined as a product of the phase shift information and the phase compensation information.

9. The method of claim 7, wherein the phase shift information and the phase compensation information are transmitted as index information in each slot.

10. The method of claim 7, wherein the phase shift information and the phase compensation information are transmitted as difference information between a current slot and a previous slot.

11. A base station comprising:
a transceiver; and
a processor configured to:
select at least two reference reconfigurable intelligent surface (RIS) devices for estimating a position of a user equipment (UE) from among a plurality of RIS devices,
estimate position information about the UE using the selected at least two reference RIS devices,
receive, via the transceiver, an uplink pilot signal of the UE through the selected at least two reference RIS devices, and
estimate a multi-RIS channel for the plurality of RIS devices based on the uplink pilot signal of the UE and the estimated position information about the UE.

12. The base station of claim 11, wherein the processor is configured to select the at least two reference RIS devices based on a distance between the base station and each of the plurality of RIS devices and a direct path between the base station and the UE.

13. The base station of claim 12, wherein the selected at least two reference RIS devices are selected in order of proximity to a direction of the direct path.

14. The base station of claim 12, wherein the selected at least two reference RIS devices are selected based on the distance, a direction of the direct path, and weights indicating precedence for the distance and the direction.

15. The base station of claim 11, wherein the processor is configured to estimate the position information about the UE based on angle information between the UE and each of the selected at least two reference RIS devices and position information about the selected at least two reference RIS devices.

16. The base station of claim 11, wherein the processor is configured to estimate a channel h_{r,k} in a reflection path between the UE and a kth RIS device except for the selected at least two reference RIS devices among the plurality of RIS devices, wherein the channel h_{r,k} is estimated through the following equation:
$${h}_{r , k} = PL ( \sqrt{{( {x}_{k} - {x}_{u} )}^{2} + {( {y}_{k} - {y}_{u} )}^{2}} ) a ( {θ}_{k} )$$
$${θ}_{k} = {tan}^{- 2} ( \frac{{x}_{u} - {x}_{k}}{{y}_{u} - {y}_{k}} )$$
wherein position information about the kth RIS device is (xₖ, yₖ), the position information about the UE is (xᵤ, yᵤ), a(θₖ) is a steering vector indicating a channel direction of the kth RIS device, a function of PL indicates a pathloss based on a distance between the base station and the kth RIS device, and θₖ indicates an angle of departure (AoD) between the UE and the kth RIS device.

17. The base station of claim 11, wherein the processor is configured to transmit codebook (RIS codeword set) information for reflecting a transmission beam of the base station to the UE to each of the plurality of RIS devices, wherein the codebook information includes at least one of phase shift information and phase compensation information applied to reflect the transmission beam of the base station through a reflecting element of each RIS device, and wherein the phase shift information indicates a beam direction to each RIS device, and the phase compensation information is information for aligning phases of signals reflected from the plurality of RIS devices.

18. The base station of claim 17, wherein the codebook information is defined as a product of the phase shift information and the phase compensation information.

19. The base station of claim 17, wherein the phase shift information and the phase compensation information are transmitted as index information in each slot.

20. The base station of claim 17, wherein the phase shift information and the phase compensation information are transmitted as difference information between a current slot and a previous slot.
